(19) United States
(12) Patent Application Publication
(10) Pub. No.: US 2003/0214166 A1
(43) Pub. Date: Nov. 20, 2003

(54) Adjustable seatback assembly

(76) Inventors: John E. Schambre, Canton, MI (US); Michael D. Tesauro, Wixom, MI (US); Michael O. Forker, Novi, MI (US)

Correspondence Address: Ralph E Smith, DaimlerChrysler Intellectual Capital Corporation, CIMS 483-02-19, 800 Chrysler Drive, Auburn Hills, MI, 48326-2757, US

(21) Appl. No.: 10/145,929

(22) Filed: May 15, 2002

(51) Int. Cl. B60N 2/64

(52) U.S. Cl. 297/353; 297/284.1

(57) ABSTRACT

A seatback assembly for a motor vehicle. The seatback assembly comprises a frame and a cushion supported on the frame. The cushion has holes therein adapted to be compressed in a vertical direction to allow the cushion to adopt a shorter height.

### TECHNICAL FIELD OF THE INVENTION

This invention relates generally to seats for motor vehicle seats, and relates more specifically to an adjustable seatback assembly.

### BACKGROUND OF THE INVENTION

Headrests for motor vehicle seats are widespread, and various arrangements are known for allowing the height of the headrest to be adjusted. For example, U.S. Pat. No. 5,071,190 shows a vehicle seat assembly with a fixed position headrest and a vertically movable seat cushion and back. U.S. Pat. No. 5,700,055 shows a similar seatback automatic height adjustor and recliner mechanism.

### SUMMARY OF THE INVENTION

The present invention is a seatback assembly for a motor vehicle. The seatback assembly comprises a frame and a cushion supported on the frame. The cushion has holes therein adapted to be compressed in a vertical direction to allow the cushion to adopt a shorter height.

Accordingly, it is an object of the present invention to provide an assembly of the type described above which can be adjusted in height.

Another object of the present invention is to provide an assembly of the type described above that has a headrest fixed with respect thereto such that the height of the headrest is also adjustable.

Still another object of the present invention is to provide an assembly of the type described above which is easy to use and cost-effective.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a perspective view of motor vehicle seat according to the present invention;

FIG. 2 is a perspective view of a seatback frame for the seat;

FIG. 3 is a perspective view of a latch for the seatback frame in a latched position;

FIG. 4 is a perspective view of the latch in an unlatched position;

FIG. 5 is a perspective view of a release lever for the seatback frame; and

FIG. 6 is a partial perspective view of the seat in a lowered position.

### DETAILED DESCRIPTION OF THE PRESENTLY PREFERRED EMBODIMENTS

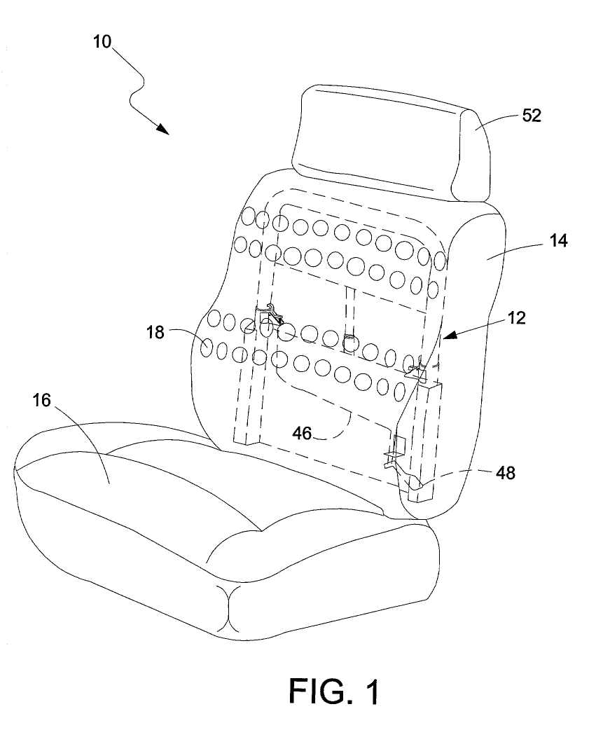

FIG. 1 shows one embodiment 10 of a motor vehicle seat according to the present invention. The seat 10 includes a seatback frame 12 that may be formed of any conventional material and covered with a foam cushion 14 and a seat cover (not shown). The seatback frame 12 is normally oriented in an upright, use position to support an occupant sitting on a seat cushion 16.

The seatback cushion 14 may be any conventional open- or closed-cell foam, and includes one or more holes 18 that extend through the cushion. In a preferred embodiment, the seatback cushion 14 includes a front half and a rear half attached respectively to the front and rear of the seatback frame 12. In particular, the seatback cushion 14 may be provided with one or more rows of holes 18, with each row having a plurality of holes. The rows of holes 18 are desirably generally horizontally arranged to allow the seatback cushion 14 to be compressed vertically, as discussed more fully below.

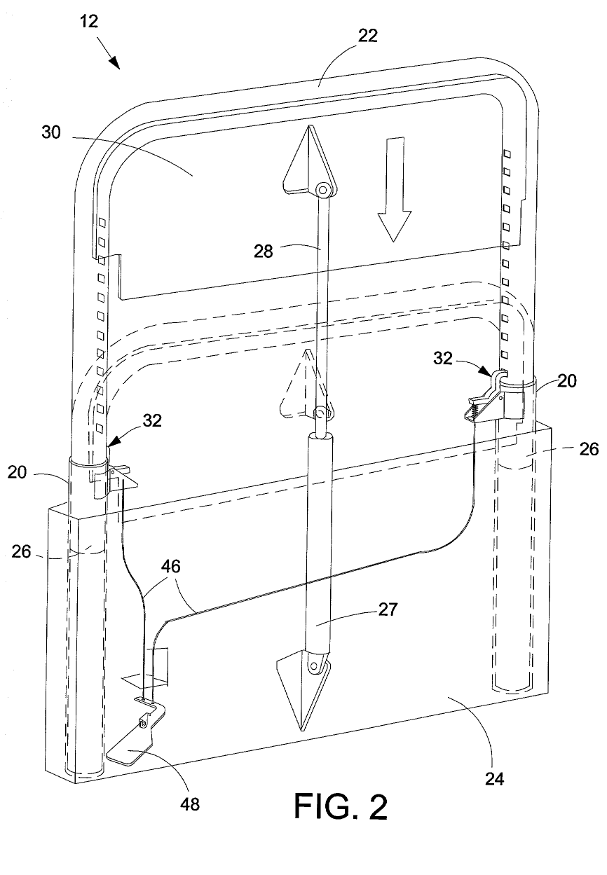

FIG. 2 shows the seatback frame 12, which includes a pair of side supports 20 and a U-shaped top member 22. The side supports 20 are mounted to a lower brace 24, and telescopically accept the lower, opposite ends 26 of the top member 22. A cylinder 27 of a gas assisted strut is pivotably attached to the lower brace 24, and a piston 28 extends from the cylinder and is pivotably attached to an upper brace 30 fixed to the top member 22. The strut biases the top member 22 upwardly and away from the side supports 20. Conversely, the top member 22 may be manually lowered in the direction of the arrow against the force of the strut to a position shown in phantom.

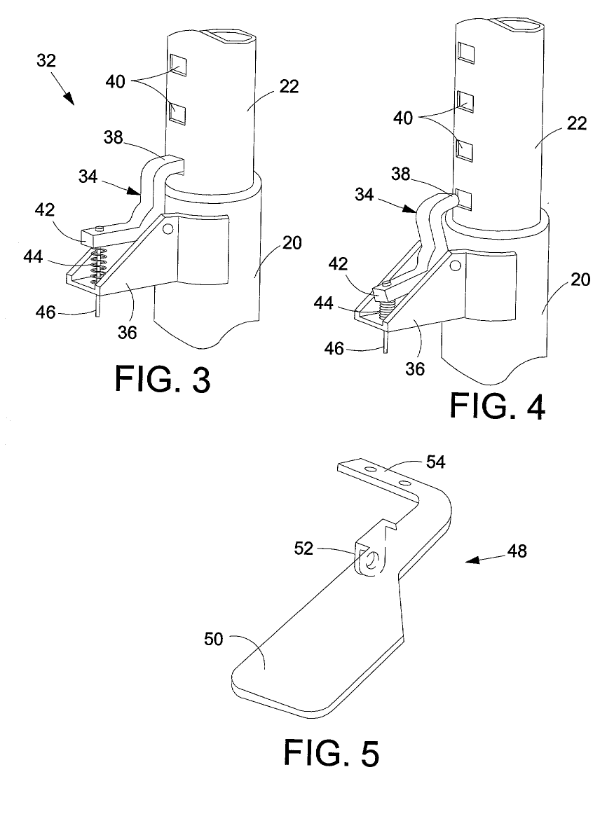

The top member 22 may be locked into position relative to the side supports 20 by a pair of latches 32, shown in greater detail in FIGS. 3 and 4. Each latch 32 includes a pawl 34 that is pivotably mounted to a support 36 fastened to a respective side support 20. One end 38 of the pawl is adapted to selectively engage one of a series of holes 40 formed along the inner side of each side support 20. The opposite end 42 of each pawl 34 is biased generally upwardly by a spring 44, which results in the pawls being normally biased toward a locking position. The springs 44 are disposed around a cable 46, which is fastened to the free end 42 of the pawl 34 and extends to a release lever 48 shown in FIG. 5. To release the pawls 34 from engagement with the holes 40 in the side supports 20, a free end 50 of the release lever 48 may be raised to pivot the release lever about a pivot point 52. The opposite end 54 of the release lever, to which the cables 46 are attached, is thereby lowered. The cables 46 are thus drawn in tension, pulling the ends 38 of the pawls 34 out of engagement with the holes 40 in the side supports 20.

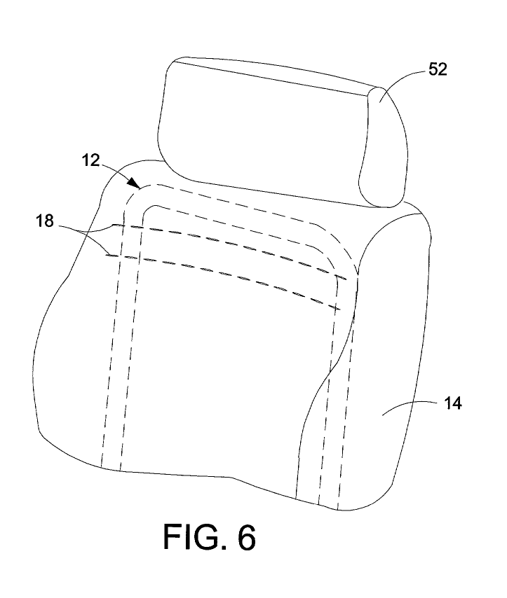

The top member 22 of the seatback frame will then be biased upwardly by the gas strut. As mentioned, however, the top member 22 can be manually forced downwardly toward a totally collapsed position. FIG. 6 shows the seatback assembly in the totally collapsed position. In this position, the holes 18 in the seatback cushion 14 are compressed, normally until they visually resemble slits. The present invention contemplates, however, that the remaining portions of the seatback cushion 14 may also be compressed to a greater density by this operation.

In this way, a headrest 52 disposed proximate the top of the seatback cushion 14 may be positioned at a variety of heights from the seat cushion 16. The seatback frame 12 may also be pivotable about a conventional pivot (not shown) between the relatively upright, operational position shown in FIG. 1 and a lowered, storage position generally parallel to the load floor of the vehicle. The entire seat 10 may likewise be forwardly foldable about a separate pivot (not shown) to a so-called “tumbled” position. With the seatback frame 12 and seatback cushion 14 fully collapsed, the seatback occupies a relatively compact space.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

1. A seatback assembly for a motor vehicle, the seatback assembly comprising:
a frame; and
a cushion supported on the frame, the cushion having holes therein adapted to be compressed in a vertical direction to allow the cushion to adopt a shorter height.

2. The seatback assembly of claim 1 wherein the holes extend through the cushion.

3. The seatback assembly of claim 1 wherein the frame comprises a lower portion and an upper portion movable relative to each other, a gas assisted strut attached between the lower portion and the upper portion, and a latch mounted on one of the lower portion or the upper portion, the latch being engagable with holes formed in the other of the lower portion or the upper portion to fix the lower portion against movement relative to the upper portion.

4. The seatback assembly of claim 3 wherein the strut is pivotably attached to the lower portion and pivotably attached to the upper portion, and the strut biases the upper portion away from the lower portion.

5. The seatback assembly of claim 1 further comprising a headrest fixed to the frame.

6. The seatback assembly of claim 5 wherein the headrest is immovable with respect to the frame.

7. A seatback assembly for a motor vehicle, the seatback assembly comprising:
a frame movable between a use position and a collapsed position; and
a cushion supported on the frame, the cushion having holes therein adapted to be compressed in a vertical direction as the frame moves toward the collapsed position to allow the cushion to adopt a shorter height.

8. The seatback assembly of claim 7 wherein the holes extend through the cushion.

9. The seatback assembly of claim 7 wherein the frame comprises a lower portion and an upper portion movable relative to each other, a gas assisted strut attached between the lower portion and the upper portion, and a latch mounted on one of the lower portion or the upper portion, the latch being engagable with holes formed in the other of the lower portion or the upper portion to fix the lower portion against movement relative to the upper portion.

10. The seatback assembly of claim 9 wherein the strut is pivotably attached to the lower portion and pivotably attached to the upper portion, and the strut biases the upper portion away from the lower portion.

11. The seatback assembly of claim 7 further comprising a headrest fixed to the frame.

12. The seatback assembly of claim 11 wherein the headrest is immovable with respect to the frame.

13. A seatback frame comprising:
a lower portion and an upper portion movable relative to each other;
a gas assisted strut attached between the lower portion and the upper portion; and
a latch mounted on one of the lower portion or the upper portion, the latch being engagable with holes formed in the other of the lower portion or the upper portion to fix the lower portion against movement relative to the upper portion.

14. The seatback frame of claim 13 wherein the lower portion comprises a pair of tubular side supports.

15. The seatback frame of claim 14 wherein the upper portion comprises a U-shaped top member telescopically received in the tubular side supports.

16. The seatback frame of claim 13 wherein the strut is pivotably attached to the lower portion and pivotably attached to the upper portion.

17. The seatback frame of claim 13 wherein the latch includes a pawl pivotably mounted on the one of the lower portion or the upper portion.

18. The seatback frame of claim 17 further comprising a spring engaged with the pawl and biasing the pawl toward the holes.

19. The seatback frame of claim 18 further comprising a cable engaged with the pawl and adapted to draw the pawl out of engagement with the holes.

20. The seatback frame of claim 13 wherein the strut biases the upper portion away from the lower portion.
